(19) United States
(12) Patent Application Publication
(10) Pub. No.: US 2019/0223659 A1
(43) Pub. Date: Jul. 25, 2019

(54) SYSTEM AND METHOD FOR CONTROLLING THE COOKING TIMER USING IOT DEVICES

(71) Applicant: Connected Cooking Solutions Private Limited, Bangalore (IN)

(72) Inventor: Bahubali SHETE, Bangalore (IN)

(21) Appl. No.: 16/166,538

(22) Filed: Oct. 22, 2018

Related U.S. Application Data
(60) Provisional application No. 62/574,872, filed on Oct. 20, 2017.

(51) Int. Cl. A47J 36/32; G05B 13/02

(52) U.S. Cl. CPC A47J 36/321; G05B 13/0265

(57) ABSTRACT

The present application provides a system and method for an automatic stove knob for cooking. The system has a stove knob configured with an IoT device, a voice enabled voice assistance device to interact with the user (s), a cloud server to store the data for processing and a mobile application installed onto the user's mobile phone to control the IoT device. The user requests for a recipe by interacting with the mobile application or voice assistance device and the cooking time and flame intensity are automatically determined and the stove knob is operated automatically for each step in the recipe. The user is alerted once the time set in the timer is over. Hence, the system controls the flame intensity and time automatically based on the set of instructions in accordance with the recipe requested by the user.

### CLAIM OF PRIORITY

This application claims priority to U.S. Provisional Patent application No. 62/574,872 filed Oct. 20, 2017, the contents of which are incorporated herein by reference in its entirety.

### FIELD OF THE EMBODIMENTS

The present invention relates to a system and method for controlling the cooking timer using IoT devices. More particularly, the invention relates to a smart stove knob or a cooking timer controlled by Internet of things (IoT) devices.

### BACKGROUND OF THE EMBODIMENTS

In the present time, IoT is gaining a lot of popularity and is seen to be reaching its peak. IoT devices are being used in all domains, including homes, industries and cities to automate operation of multiple devices and take smart decisions based on data collected from sensors. One such domain of interest for IoT technology is kitchen appliances. IoT devices can assist users in performing multiple tasks in the kitchen, from providing cooking assistance to automating cooking and purchase of cooking items.

Some of the examples of such IoT implementations in the kitchen are generating notifications to replenish the unavailable ingredients, intimating the nearest groceries to deliver the required items, providing a list of recipes to the user (s) based on the availability of ingredients, suggesting the recipes to the user based on previous cooking history, etc. However, these systems often require human intervention for controlling multiple functions like switching (ON/OFF) the stove knob, set the timer for electronic appliances, and control the flame intensity using the stove knob and many more.

Hence, the existing devices fail to provide a complete automated solution for cooking. For example, current solutions for cooking stoves knobs need to be turned off manually in order prevent burning of food, kitchen fires, etc. In the market, there are a few smart knob accessories that produce an alert noise once the timer set by a user has expired. However, this still requires human intervention to determine the time required and set the timer.

Hence, there is a need of a system and method for a smart stove knob solution with an automated timer, which controls the flame intensity and operates automatically based on the set of instructions mentioned in the recipe.

### SUMMARY OF THE EMBODIMENTS

The present invention provides a method and system for automatic operation of cooking stove knob based on cooking time required in accordance with a recipe.

The present application disclosed a method of automatically controlling cooking timer and flame intensity of a stove knob, the method comprising the steps of: receiving request for a recipe from a user; determining cooking time and flame intensity required for each step of the recipe; triggering step by step execution of each step in the recipe; sending data parameters related to intensity of flame and cooking time; correlating received data parameters with stored steps of cooking in the recipe to monitor cooking time and flame intensity for each step of the recipe; controlling intensity of flame and cooking time based on the correlation results; alerting the user upon completion of cooking timer for all steps in the recipe; automatically switching off the flame upon completion all steps in the recipe.

The present application's method also comprises wherein the request for a recipe is received in form of audio command. The method further comprises alerting the user upon detection of user's location outside a pre-defined boundary based on geo-fencing and alerting the user upon detection of smoke during cooking. The method further comprises implementing machine learning for interpreting the recipe, determine cooking timer time period and flame intensity from the recipe and learning from user feedback.

The present application discloses a system for providing automatically controlled cooking timer and flame intensity, the system comprising: a communication device for receiving a request for a recipe from the user; a stove knob for controlling cooking time and flame intensity for each step in the requested recipe and triggering execution of each step in the recipe; a sensor device for monitoring parameters related to cooking time and flame intensity at the stove and sending the parameters to a cloud server and controlling operation of the stove knob; a cloud server for correlating the parameters received from the sensor device with stored set of instruction for a recipe, monitoring cooking time and flame intensity based on the correlation results and sending instructions for operation of stove knob to the sensor device; a mobile communication device for receiving notification upon completion of all steps in the recipe.

The present application's system further comprises a machine learning engine for interpreting the recipe, determine cooking timer time period and flame intensity from the recipe and learning from user feedback. The system also comprises wherein the communication device is a voice enabled assistant. The system comprises wherein the sensor device is connected to the cloud server over internet. The system comprises wherein the cloud server sends notification to mobile communication device in the event of detection of smoke.

### BRIEF DESCRIPTION OF THE DRAWINGS

FIG. 1 illustrates a block diagram of the system in accordance with the present invention for controlling the stove knob.

FIG. 2 illustrates a process flow diagram of a method for controlling the stove knob, in accordance with the present invention.

### DETAILED DESCRIPTION OF THE EMBODIMENTS

Described herein are the methods, computer systems and software for providing an automatic cooking stove knob. The following detailed description of the invention refers to the accompanying drawings. Various changes and modifications obvious to one skilled in the art to which the invention pertains are deemed to be within the spirit, scope and contemplation of the invention.

The term “IOT device” as claimed in the present invention refers to computing device (sensors) that connects wirelessly to a network and has the ability to transmit and receive data over the internet.

The system in accordance with the invention comprises of a stove knob coupled with an IoT device, a voice enabled voice assistance device to interact with the user (s), a cloud server to store the data for processing and a mobile application installed onto the mobile phone to control the IoT device. The present invention allows the user (s) to set the cooking time automatically alerts when the timer expires. Therefore, the system controls the flame intensity automatically based on the set of instructions mentioned in the recipe.

The present invention provides a system which helps the user(s) to execute the set of instructions using an automated stove knob. The system is operated through a sensor within IoT device which is mounted on the stove knob. The sensor collects parameters related to operation of the stove knob and correlates with the stored set of instructions in the cloud server to control the intensity of flame along with a timer, as mentioned in the set of instructions (recipe).

The present system monitors and calibrates the cooking time automatically, and suggests user(s) to take required actions. The user(s) need not keep checking or setting timers at set intervals of time for each step of the recipe. The present invention also eliminates the problems associated with unattended cooking like burnt food, over cooking, kitchen fire etc.

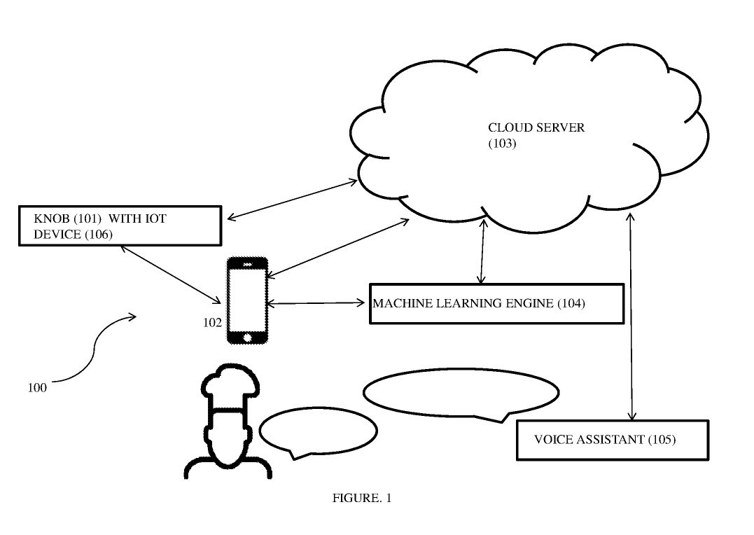

FIG. 1 illustrates the block diagrams of a system 100 for controlling the cooking timer using IoT device, in accordance with an embodiment of the invention. The system comprises of a stove knob (101) which is configured with an IoT device (106). The IoT device (106) senses and sends the data to a cloud server (103), wherein the data is correlated with the set of instruction (recipe). The system also uses a machine learning engine (104) to interpret the recipes, determine cooking timer time period and flame intensity from the recipe and to learn from user feedback and improvise. The system further comprises a mobile application (102) that the user installs on his/her mobile device. The mobile application (102) enables user to activate/deactivate the IoT device, enable its connection to the cloud through internet, and provide user input and to provide updates to the user regarding the knob operation or cooking events. The user could also interact with a voice assistant (105) to request for a recipe, provide feedback and user input and to receive set of instructions in accordance with the requested recipe. The stove knob (101) automatically controls the intensity of the flame and time of operation, based on the set of instructions in the recipe requested by the user. The cloud server (103) is used to store the data for processing and a mobile application (102) is installed onto the user's mobile phone to control the IoT device (106). After the user requests for a recipe to cook, using the voice assistant (105) or the mobile application (102), the smart knob (101) sets the cooking time and intensity of the flame automatically, based on the steps of instructions in the recipe and alerts the user once the time set in the timer is over for all steps in the recipe.

In one of the embodiments of the invention, a machine learning engine (104) is used to interpret instructions cited in the recipe(s) and determine cooking time and intensity of flame required for each step of cooking. The machine learning engine (104) also learns new recipe(s) and sets time automatically based on the previous cooking history. It learns user behavior based on the user history stored in the cloud server (103) and calibrates the cooking time automatically. Also, the machine learning engine (104) receives user input and feedback to further improve the system's performance.

In another embodiment of the invention, when the stove knob (101) is turned ON, the present system prompts the user to interact through the mobile application(102) or smart voice assistant(105) and determines the recipe being cooked based on user input. The system then determines a cooking time automatically and sets a cooking timer for the smart knob, along with required intensity of flame for each step in the recipe. Once the cooking timer expires for all steps, the system alerts the user of the same and switches off the knob.

In the preferred embodiment of the present invention, the knob (101) is mounted directly on the stove and configured with an IOT device (106). The knob (101) may be used as timer and as a flame intensity controller, which can be operated independently. The IOT device (106) configured with the knob (101) keeps track of the flame intensity and monitors the cooking time, wherein the cooking time is further calibrated based on the flame intensity.

In another embodiment of the present invention, the system is location aware and alerts the user based on geo-fencing for user security. The system tracks the location of the user and sends a notification in form of a text message or email alert or notification in the mobile application (102) when the user enters (or exits) a pre defined boundary.

In the preferred embodiment of the present invention, the stove knob (101) and IoT device (106) may be connected to the internet directly or through a gateway.

The IoT device (106) in the system is used to measure multiple parameters on the smart knob (101), including but not limited to flame intensity, time of cooking, frequency of operation, smoke levels etc. and sends the collected data to the cloud server (103). The IoT device (106) comprises multiple sensors to detect the operation state of cooking timer, current intensity of the flame, smoke levels, heat levels etc. The sensors detect the required data parameters and send the parameters to the cloud server (103). The IoT device then compares the parameters with instruction set received from the cloud server (103) for the requested recipe and controls operation of the stove knob (101) accordingly. The cloud server (103) also performs analysis of the collected data to understand user behavior, monitor cooking timer and flame, cooking conditions such as burning of food etc and controls operation of the stove knob (101) accordingly.

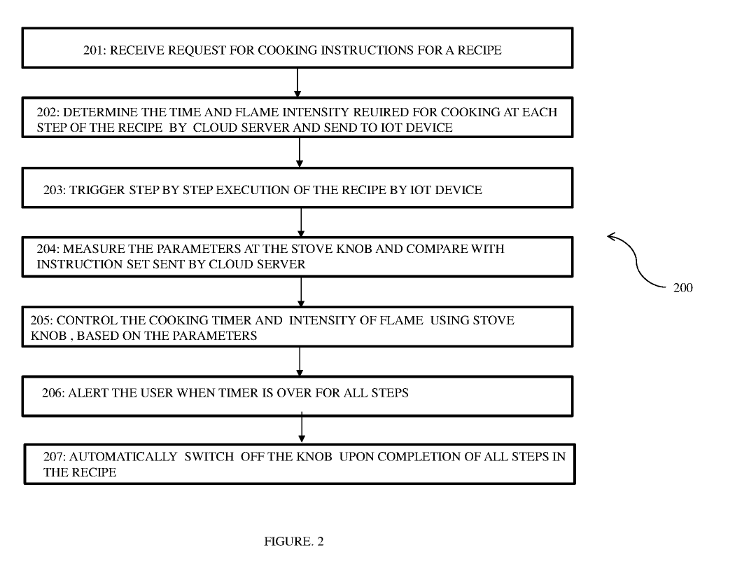

FIG. 2 illustrates a process flow of a method for controlling the cooking timer in accordance with an embodiment of the invention. The method 200 initiates with the step 201, wherein the user interacts with a voice assistant or mobile application to request cooking instructions for a recipe. At step 202, the time and flame intensity for cooking at each step of the recipe are determined and sent by the cloud server to the IoT device. At step 203, the cooking process is started by triggering step by step execution of the recipe by the IoT device. At step 204, the parameters related to the stove are measured by the IoT device and sent to the cloud for monitoring operation of stove knob by correlating the recorded parameters with the set of cooking instructions stored the cloud server, for the requested recipe. At step 205 the IoT device monitors operation of the stove knob based on the instructions received from the cloud server. The intensity of flame is controlled for each step in the recipe for a certain time at each step, based on the processed parameters. At step 206, the user is alerted when the time set in the timer is over for all steps Finally, at step 207, the smart knob is switched OFF automatically upon completion of all steps in the recipe.

In one of the embodiments of the present invention, the parameters relate to a stove knob are recorded by IoT device and sent to the cloud server for analysis. The parameters are correlated with the stored set of instructions in the cloud server to control the intensity of flame along with a timer, as mentioned in the set of instructions (recipe). Based on this analysis, the cloud server sends a set of instructions for operation of the stove knob, for each step of the recipe.

The embodiments in accordance with the present invention can be implemented with any combination of hardware and software. If implemented as a computer implemented apparatus, the present invention can be implemented using means for performing all of the steps and functions described above.

Although the description above illustrates the present invention with many specific examples, these should not be construed as limiting the scope of the invention buy merely as illustrating some of the presently preferred embodiments of this invention. Thus, the scope of the invention should be determined by the appended claims and any and all equivalents thereof, rather than the examples given. It should be understood that various changes and substitutions could be made herein without departing from the spirit and scope of the invention.

What is claimed is:

1. A method of automatically controlling a cooking timer and flame intensity of a stove knob, the method comprising the steps of:
receiving a request for a recipe from a user;
determining the cooking time and the flame intensity required for each step of the recipe;
triggering a step by step execution of each step in the recipe;
sending data parameters related to the intensity of flame and the cooking time;
correlating received data parameters with stored steps of cooking in the recipe to monitor the cooking time and the flame intensity for each step of the recipe;
controlling the intensity of flame and the cooking time based on the correlation results;
alerting the user upon completion of the cooking timer for all the steps in the recipe;
automatically switching off the flame upon completion of all the steps in the recipe.

2. A method of claim 1, wherein the request for a recipe is received in form of an audio command.

3. A method of claim 1, further comprising alerting the user upon detection of a user's location outside a pre-defined boundary based on geo-fencing.

4. A method of claim 1, further comprising alerting the user upon detection of smoke during cooking.

5. A method of claim 1, further comprising implementing machine learning for interpreting the recipe, determining the cooking timer time period and the flame intensity from the recipe and learning from user feedback.

6. A system for providing automatically controlled cooking timer and flame intensity, the system comprising:
a communication device for receiving a request for a recipe from a user;
a stove knob for controlling the cooking time and the flame intensity for each step in the requested recipe and triggering execution of each step in the recipe;
a sensor device for monitoring parameters related to the cooking time and the flame intensity at the stove and sending parameters to a cloud server and controlling operation of the stove knob;
a cloud server for correlating the parameters received from the sensor device with a stored set of instruction for the recipe, monitoring the cooking time and the flame intensity based on correlation results and sending instructions for operation of the stove knob to the sensor device;
a mobile communication device for receiving notification upon completion of all steps in the recipe.

7. The system in accordance with claim 6 further comprising a machine learning engine for interpreting the recipe, determining the cooking timer time period and the flame intensity from the recipe and learning from user feedback.

8. The system in accordance with claim 6 wherein the communication device is a voice enabled assistant.

9. The system in accordance with claim 6 wherein the sensor device is connected to the cloud server over internet.

10. The system in accordance with claim 6 wherein the cloud server sends notification to mobile communication device in the event of detection of smoke.
